(19) United States
(12) Patent Application Publication
(10) Pub. No.: US 2010/0261600 A1
(43) Pub. Date: Oct. 14, 2010

(54) METAL STRUCTURE, CATALYST-SUPPORTED METAL STRUCTURE, CATALYST-SUPPORTED METAL STRUCTURE MODULE AND PREPARATION METHODS THEREOF

(75) Inventors: Wang-Lai YOON, Daejeon (KR); Kee-Young KOO, Gwangju (KR); Hyun-Ku JOO, Daejeon (KR); Jae-Kyung YOON, Daejeon (KR); Un-Ho JUNG, Daejeon (KR)

Correspondence Address: ARENT FOX LLP, 1050 CONNECTICUT AVENUE, N.W., SUITE 400, WASHINGTON, DC, 20036, US

(73) Assignee: KOREA INSTITUTE OF ENERGY RESEARCH, Daejeon (KR)

(21) Appl. No.: 12/539,882

(22) Filed: Aug. 12, 2009

(30) Foreign Application Priority Data
Apr. 14, 2009 (KR) 10-2009-0032204

(51) Int. Cl. B01J 23/86; B01J 23/26; B01J 37/34

(52) U.S. Cl. 502/5; 502/439; 502/316

(57) ABSTRACT

The present invention provides a metal structure for a compact reformer and a preparation method thereof, a catalyst-supported metal structure and a preparation method thereof, and a catalyst-supported metal structure module. More particularly, the present invention relates to a metal structure prepared through electrochemical treatment and heat treatment and a preparation method thereof, a catalyst-supported metal structure prepared by supporting a catalyst on the metal structure and a preparation method thereof, and a catalyst-supported metal structure module manufactured by irregularly layering the catalyst-supported metal structures to improve the contact between reaction gases and catalysts.

### BACKGROUND OF THE INVENTION

1. Field of the Invention

The present invention relates to a metal structure for a compact reformer and a preparation method thereof, a catalyst-supported metal structure and a preparation method thereof, and a catalyst-supported metal structure module. More particularly, the present invention relates to a metal structure prepared through electrochemical treatment and heat treatment and a preparation method thereof, a catalyst-supported metal structure prepared by supporting a catalyst on the metal structure and a preparation method thereof, and a catalyst-supported metal structure module manufactured by irregularly layering the catalyst-supported metal structures to improve the contact between reaction gases and catalysts. That is, the present invention relates to technologies applied to a compact reformer which is conceptually different from a conventional packed-bed catalytic reactor or monolithic catalytic reactor.

2. Description of the Related Art

In conventional chemical processes (hydrogenation, desulfurization and the like), a packed-bed catalytic reactor has been used. However, such a packed-bed catalytic reactor is problematic in that its catalytic efficiency is decreased due to low heat and mass transfer rates and in that its volume is increased. Really, Xu & Froment reported in the thesis “AIChE J, 35, 1989, 97” that, in the case of a steam-reforming reaction, mass transfer resistance through catalyst pores is very high because the catalytic effectiveness factor is about 0.03. Further, such a packed-bed catalytic reactor is problematic in that its performance is deteriorated due to high pressure loss and the channeling of reactants and in that its response characteristics are slow due to the change in initial starting time and load.

In order to solve the problem with the pressure loss of the conventional packed-bed catalytic reactor, a channeled structure has been used as a catalyst carrier. In particular, in a high-temperature process such as a steam-reforming reaction, a metal structure having excellent heat transfer characteristics, instead of a ceramic structure having low thermal impact resistance, has been used as a catalyst carrier (Korean Patent Application Nos. 10-1993-0701567 and 10-2003-0067042)

Generally, a metal structure has a cell density of about 200˜400 cpi, and is characterized in that the ratio (L/D) of channel length to channel diameter is about 70˜120. Owing to this channel characteristic, the metal structure is disadvantageous in that heat transfer and mass transfer are limited because a boundary layer is formed on the inner surface of a channel and in that it is difficult to uniformly coat the inner surface of a channel with a catalyst because of a capillary phenomenon.

The metal structure is generally fabricated in the form of monolith, mat, foam or mesh. When a metal material is used as a catalyst carrier, there is a problem in that a ceramic catalyst or a catalyst carrier is detached from the metal structure at high temperature due to the difference in the thermal expansion coefficient between metal and ceramic, thus deteriorating the durability and activity of a catalyst.

In order to ensure the stability to thermal shock of the catalyst adhered to the surface of the metal structure and to improve the adhesion force between the catalyst and the metal structure, technologies related to metal monolith catalysts have been developed.

Korean Patent Application No. 10-2002-0068210 discloses a method of manufacturing a monolith catalyst module including a metal structure. In the method, in order to improve the adhesion force between metal and catalyst, the metal structure is primarily coated with aluminum particles serving as an anti-corrosion film, and then secondarily coated thereon with aluminum particles serving as a carrier. Subsequently, the coated metal structure is heat-treated to prevent the occurrence of cracking or peeling, and is then oxidized at high temperature to form a metal oxide layer. Finally, the metal oxide layer is coated with a catalyst through a wash coating method, thereby manufacturing the monolith catalyst module including the metal structure.

Further, Korean Patent Application No.10-2005-0075362 discloses a catalyst coating technology. In the catalyst coating technology, in order to increase the adhesion force between a substrate and a catalyst, an adhesive layer made of a material having the same surface properties as a catalyst is formed on the substrate using atomic layer deposition (ALD) or chemical vapor deposition (CVD). This catalyst coating technology is advantageous in that the substrate can be uniformly coated with the adhesive layer to a desired thickness regardless of the kind and shape of the substrate. However, in this catalyst coating technology, hydroxy groups react with metal precursors to repeatedly form M-OH (M: metal) bonds, thus forming metal oxides. Therefore, this catalyst coating technology is problematic in that it cannot be easily and commercially used, considering that specific metal precursors which react with hydroxy groups to be able to form M-O-M bonds are limited and that this catalyst coating technology must be performed under vacuum using expensive reaction apparatuses.

FIG. 5 is a photograph showing the separation of an aluminum oxide layer applied on the surface of a metal support heat-treated at a high temperature of 900° C. or more for a long time. Fecralloy, which is chiefly used as a metal structure of a catalyst because of high-temperature thermal stability, must undergo a heat treatment process at a high temperature of 900° C. or more for a long time to form an aluminum oxide layer on the surface of a metal structure in order to increase the adhesion force between the metal structure and a catalyst. The aluminum oxide layer formed on the surface of the metal structure through the heat treatment process is problematic in that, since the aluminum oxide layer is non-uniformly formed, interlayer adhesion force is decreased when it is coated with a catalyst carrier or a catalyst layer, so that it easily becomes separated.

### SUMMARY OF THE INVENTION

Accordingly, the present invention has been made to solve the above-mentioned problems, and an object of the present invention is to provide a method of preparing a metal structure by forming a uniform metal oxide layer on the surface of a metal support through electrical surface treatment and heat treatment, and a metal structure prepared using the method.

Another object of the present invention is to provide a method of preparing a metal structure by forming a uniform metal oxide layer on the surface of a metal support through electrical surface treatment and heat treatment, by which only a predetermined metal oxide layer can be selectively formed on the surface of the metal support such that the adhesion force of the metal support made of a single metal material or an alloy material containing various components is increased without limiting the composition and surface state of the metal support and such that the metal oxide layer which can serve as a catalyst carrier is uniformly formed on the surface of the metal support.

Still another object of the present invention is to provide a method of preparing a catalyst-supported metal structure, in which a metal oxide layer is uniformly formed on the surface of a metal support through electrochemical surface treatment and heat treatment and then the metal oxide layer is highly-dispersed and supported with a catalyst to increase the adhesion force between the metal structure and the catalyst and improve the durability of the catalyst.

Still another object of the present invention is to provide a catalyst-supported metal structure module manufactured by irregularly layering the catalyst-supported metal structures to increase the contact area between reaction gases and catalysts.

Still another object of the present invention is to provide a catalyst-supported metal structure module which has a short channel characteristic having the ratio (L/D) of channel length to channel diameter set to 0.5 or less, in order to overcome the problems of a conventional metal monolith structure.

Still another object of the present invention is to provide a catalyst-supported metal structure module which can minimize mass transfer resistance by bringing reactants into contact with a catalyst for a short time and by which a compact reformer can be designed by increasing the fuel treatment amount per unit time and thus decreasing the volume of a reactor.

In order to accomplish the above objects, an aspect of the present invention provides a method of preparing a metal structure for a compact reformer, including the steps of: washing a metal support to remove pollutants therefrom; electrochemically surface-treating the washed metal support by controlling an applied voltage and an electrolyte concentration to form an amorphous metal oxide layer on the metal support; and heat-treating the electrochemically surface-treated metal support in a heating furnace under an oxidation atmosphere to crystallize the amorphous metal oxide layer formed on the metal support or to form a metal oxide layer including a specific metal component.

In the electrochemical surface-treatment step, any one selected from among copper coil, iron coil and platinum coil is used as a cathode, the metal support is used as an anode, the electrolyte is selected from fluorine acid, phosphoric acid, sodium fluoride, sodium nitrate and combinations thereof, and a voltage of 2˜30 V is applied between the cathode and anode for 5˜60 minutes at room temperature.

The heat treatment step is performed under an oxidation atmosphere of 700˜1100° C.

The metal support is made of any one selected from among stainless steel, Fecralloy, aluminum, titanium and alloys thereof.

The metal support may have an area opening percentage of 20˜60%. The metal support can be formed thereon with a uniform metal oxide layer and can be coated thereon with a catalyst through the electrochemical surface treatment of the present invention regardless of the shape thereof.

The metal support has a ratio of channel length to channel diameter of 0.5 or less.

The method of preparing a metal structure for a compact reformer further includes a washing step between the electrochemical surface treatment step and the heat treatment step.

Another aspect of the present invention provides a metal structure for a compact reformer, prepared using the method of preparing the metal structure, wherein the metal oxide layer is uniformly formed on the surface of the metal support, and the metal structure has a large specific surface area.

Still another aspect of the present invention provides a method of preparing a catalyst-supported metal structure for a compact reformer, including the steps of: washing a metal support to remove pollutants therefrom; electrochemically surface-treating the washed metal support by controlling an applied voltage and an electrolyte concentration to form an amorphous metal oxide layer on the metal support; heat-treating the electrochemically surface-treated metal support in a heating furnace under an oxidation atmosphere to crystallize the amorphous metal oxide layer formed on the metal support or to form a metal oxide layer including a specific metal component, thus preparing a metal structure; and supporting a catalyst on a surface of the metal structure.

The method of preparing a catalyst-supported metal structure for a compact reformer further includes the step of coating the metal oxide layer of the metal structure with a catalyst carrier to increase an adhesion force between the metal structure and the catalyst, before the step of supporting the catalyst on the surface of the metal structure.

The catalyst carrier is any one selected from among alumina, boehmite, silica and titania.

In the step of coating the metal oxide layer of the metal structure with the catalyst carrier, the metal oxide layer of the metal structure is coated with a mixture of the catalyst carrier and a binder to increase adhesive force between the metal structure and the catalyst.

The binder is any one selected from among poly vinyl alcohol, acetic acid, citric acid, and poly ethylene glycol.

The catalyst supported on the metal structure is any one selected from among nickel, platinum, ruthenium, ceria, zirconia, and a ceria-zirconia mixture.

In the electrochemical surface-treatment step, any one selected from among copper coil, iron coil and platinum coil is used as a cathode, the metal support is used as an anode, the electrolyte is selected from fluorine acid, phosphoric acid, sodium fluoride, sodium nitrate and combinations thereof, and a voltage of 2˜30 V is applied between the cathode and anode for 5˜60 minutes at room temperature.

The heat treatment step is performed under an oxidation atmosphere of 700˜1100° C.

The metal support is made of any one selected from among stainless steel, Fecralloy, aluminum, titanium and alloys thereof.

The metal support may have an area opening percentage of 20˜60%. The metal support can be formed thereon with a uniform metal oxide layer and can be coated thereon with a catalyst through the electrochemical surface treatment of the present invention regardless of the shape thereof.

The metal support has a ratio of channel length to channel diameter of 0.5 or less.

The method of preparing a catalyst-supported metal structure for a compact reformer further includes a washing step between the electrochemical surface treatment step and the heat treatment step.

Still another aspect of the present invention provides a catalyst-supported metal structure for a compact reformer prepared using the method of preparing a catalyst-supported metal structure, wherein the catalyst is highly-dispersed and supported on the metal oxide layer.

Still another aspect of the present invention provides a catalyst-supported metal structure module for a compact reformer, manufactured by irregularly layering a plurality of the catalyst-supported metal structures prepared using the method of preparing a catalyst-supported metal structure.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view showing a catalyst-supported metal structure according to the present invention;

FIG. 2A is a scanning electron microscope (SEM) photograph showing the surface of a fresh metal structure (sample 1) which is only washed according to the present invention;

FIG. 2B is a scanning electron microscope (SEM) photograph showing the surface of a metal structure (sample 5) which is electrochemically surface-treated according to the present invention;

FIG. 2C is a scanning electron microscope (SEM) photograph showing the surface of a metal structure (sample 14) which is electrochemically surface-treated and then heat-treated according to the present invention;

FIG. 2D is a scanning electron microscope (SEM) photograph showing the surface of a metal structure (sample 21) which is only heat-treated without electrochemical surface treatment according to the present invention;

FIG. 3A is a scanning electron microscope (SEM) photograph showing the surface of a metal structure which is electrochemically surface-treated, heat-treated and then supported with nickel according to the present invention;

FIG. 3B is a scanning electron microscope (SEM) photograph showing the surface of a metal structure which is only heat-treated and then supported with nickel according to the present invention;

FIG. 4 is a schematic view showing a catalyst-supported metal structure module according to the present invention; and

FIG. 5 is a photograph showing the separation of an aluminum oxide layer applied on the surface of a metal support heat-treated at a high temperature of 900° C. or more for a long time.

### DESCRIPTION OF THE PREFERRED EMBODIMENTS

Hereinafter, preferred embodiments of the present invention will be described in detail with reference to the attached drawings. Further, in the description of the present invention, when it is assumed that the detailed description of the related art would obscure the gist of the present invention, the description thereof will be omitted.

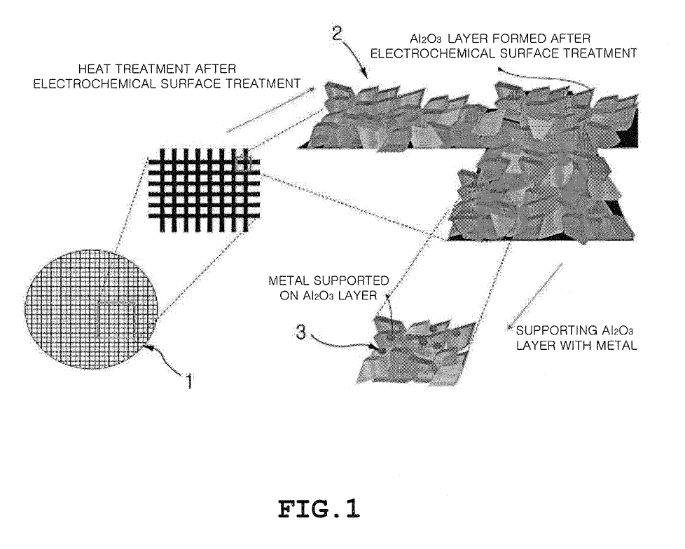

FIG. 1 is a schematic view showing a catalyst-supported metal structure according to the present invention. As shown in FIG. 1, the catalyst-supported metal structure includes a metal support 1, an aluminum oxide layer 2 uniformly formed on the metal support 1, and a catalyst 3 formed on the aluminum oxide layer 2.

In the following description, the metal support is referred to as “an initial metal structure”, and the metal structure is referred to as “a metal structure which is electrochemically and thermally treated”.

In order to provide the above metal structure, the present invention proposes a surface treatment method for improving the adhesion force of the metal structure made of a single metal material or an alloy material containing various components (for example, Fecralloy, stainless steel or the like) without limiting the composition or surface state of the metal support.

Specifically, the present invention introduces an electrochemical surface treatment method and a heat treatment method which can increase the adhesion force between the metal oxide layer and catalyst by selectively forming only a predetermined metal oxide layer on the surface of the metal support and which can uniformly form the metal oxide layer serving as a catalyst carrier on the surface of the metal support.

A method of preparing a metal structure, which is performed before the preparation of a catalyst-supported metal structure, is as follows.

The method of preparing a metal structure includes: a primary washing step of primarily washing a metal support with acetone and distilled water to remove pollutants therefrom; an electrochemical surface treatment step of oxidizing the surface of the washed metal support (Fecralloy) serving as an anode in a 0.5˜3% fluorine acid (HF) electrolyte using any one of copper coil, iron coil and platinum coil as a cathode, which is a counter electrode of the anode; and a heat treatment step of heat-treating the electrochemically surface-treated metal support in a heating furnace at a temperature of 700˜1100° C. under an oxidation atmosphere in which a temperature increase rate can be controlled.

The method may further include a secondary washing step of secondarily washing the electrochemically surface-treated metal support after the electrochemical surface treatment step. The reason why the method further includes the secondary washing step is that the electrolyte solution remaining on the surface of the electrochemically surface-treated metal support is removed.

As shown in FIG. 1, the metal support is formed of thin metal wires, and the ratio (L/D) of channel length to channel diameter thereof is 0.1˜0.5. In the influence of heat transfer and mass transfer depending on the change in flow rate of the reaction gas, when the ratio (L/D) is 0.5 or less, the mass transfer coefficient of the reaction gas is greatly changed with the increase in the flow rate of the reaction gas, whereas, when the ratio (L/D) is more than 0.5, the mass transfer coefficient of the reaction gas is slightly changed with the increase in the flow rate of the reaction gas. That is, when the contact time between reactants and catalysts is shortened due to rapid flow rate, a metal structure having an L/D of 0.5 or less, the heat and mass transfer coefficients of which are high, is advantageous. In the L/D, L is the length of a channel through which fluids flow, and D means the diameter of a channel.

Due to the above configuration, the problem that conventional pellet catalysts are not frequently used because of their heat and mass transfer resistances can be solved.

In the present invention, the metal support is characterized by having an area opening percentage of 20˜60%, but the metal support can be highly-dispersed and coated with catalysts by forming an oxide layer thereon using the electrochemical surface treatment method of the present invention regardless of shapes.

The metal support is made of any one selected from among stainless steel, Fecralloy, aluminum, titanium and alloys thereof. The reason why metals or alloys thereof are used to make the metal support is that conventional reactors used in high-temperature reactions are generally made of an alloy material such as stainless steel, Fecralloy or the like, in order to improve corrosion resistance and high-temperature stability. In conventional electrochemical surface treatment, a single metal material is used to form a metal oxide layer. However, in the electrochemical surface treatment of the present invention, in addition to the single metal material, alloy materials containing different components and thus having improved properties are used to selectively form a desired metal oxide layer.

In the electrochemical surface treatment step performed before the heat treatment step, it is suitable that 5 to 30 V of voltage be applied to both electrodes. When the voltage is less than 5 V, oxides are irregularly formed, and, when the voltage is more than 30 V, an oxide layer becomes detached. From about 5 to 60 minutes are taken to complete electrochemical surface treatment. Here, the reason for limiting numerical values is that when the time is less than 5 minutes, oxide film formation is incomplete due to insufficient elution,and, when the time is more than 60 minutes, the metal having a predetermined thickness breaks or the shape of the metal oxide is influenced by excessive elution.

About 0.5 wt % of fluorine acid is used as the electrolyte. When the amount of fluorine acid is less than 0.5 wt %, the voltage used for surface treatment needs to be higher, and it takes more time to carry out the surface treatment. When the amount thereof is more than 1 wt %, rapid oxidation occurs even when the applied voltage is low, so that it is difficult to make stable electrodes.

Further, examples of the electrolytes used in the metal support may include fluorine acid, phosphoric acid, sodium fluoride, sodium nitrate and combinations thereof.

Among the electrolytes, fluorine acid enables the thickness of an oxide layer to be suitably maintained due to high oxide dissolution rate when it is used in Fecralloy. However, when sodium fluoride, phosphoric acid, sodium nitrate or the like is used in Fecralloy, the thickness of an oxide layer is rapidly increased due to a low oxide dissolution rate, and a thick oxide layer is formed due to the decrease in surface roughness, thus causing a detachment phenomenon.

As described above, in the electrochemical surface treatment step, it is very important to adjust the applied voltage and electrolyte concentration. Otherwise, the roughness of the metal surface decreases, so that the specific surface area thereof decreases, thereby changing the surface shape thereof. Further, the metal components eluted from the metal surface are changed, thus forming an undesired metal oxide layer.

The heat treatment step performed after the electrochemical surface treatment step is used to crystallize the amorphous oxide layer formed through an electrochemical surface treatment method, and, in the case of alloys, to form an oxide layer including desired specific metal components on the metal support through a melting process.

The heat treatment temperature can be adjusted from 700° C. to 1100° C. depending on the components of the metal. The reason for imposing numeric limitations on the temperature is that when the heat treatment temperature is lower than 700° C., crystals are not formed, and, when the heat treatment temperature is higher than 1100° C., the surface of the metal support becomes agglomerated, thus decreasing the surface area of the metal support.

For example, in the case of Fecralloy, an alumina layer can be sufficiently formed on the entire surface of the metal support when it is heat-treated at 900° C. for about 6 hours, not when it is treated for a long period of time, such as 10 hours or more. That is, the temperature and time of the heat treatment process are factors important to crystal growth. The metal oxide layer is not uniformly formed when only the heat treatment is performed without performing the electrochemical surface treatment, and is difficult to be completely formed even when the heat treatment is performed at 900° C. for 6 hours or less.

Further, the present invention provides a method of preparing a catalyst-supported metal structure using the metal structure obtained through the above electrochemical surface treatment and heat treatment. The method includes the step of supporting a catalyst on the surface of the above-prepared metal structure.

The catalyst supported on the metal structure is any one selected from among nickel, platinum, ruthenium, ceria, zirconia, and a ceria-zirconia mixture.

In the step of supporting a catalyst on the surface of the metal structure, which is performed after the heat treatment step, the catalyst may become supported on the surface of the metal structure by directly immersing the metal structure into a catalyst precursor solution or may be supported thereon after primarily coating the surface of the metal structure with a carrier (alumina, boehmite, silica, titania, or the like).

As such, upon coating the metal oxide layer with the carrier, the carrier may be mixed with a binder and then applied to the metal support in order to improve the adhesive force. As the binder, poly vinyl alcohol, acetic acid, citric acid, poly ethylene glycol or the like may be used.

Furthermore, the catalyst may be adhered onto the surface of the metal structure by either directly impregnating the catalyst in the catalyst precursor or by using a wash coating method after mixing the catalyst with alumina sol.

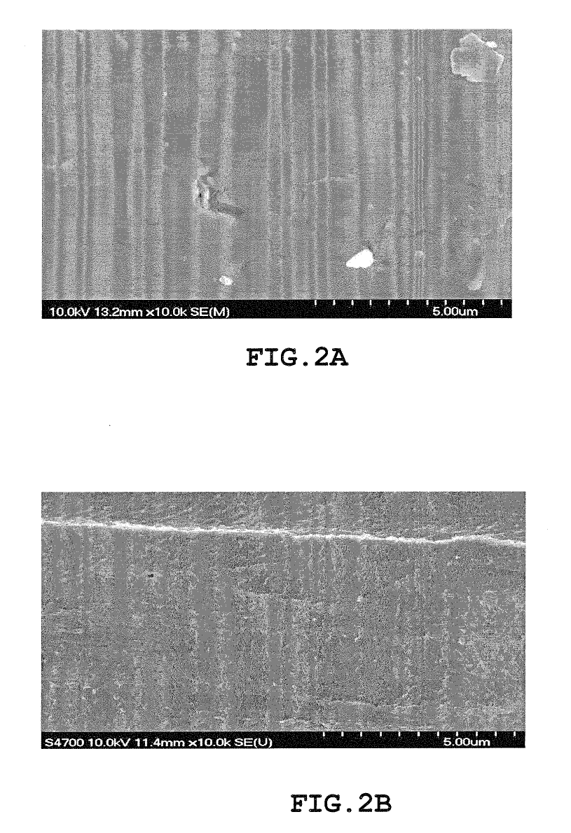

FIG. 2A is a scanning electron microscope (SEM) photograph showing the surface of a fresh metal structure (sample 1) which was only washed according to the present invention. That is, FIG. 2A shows the surface state of sample 1 which was primarily washed before the electrochemical surface treatment and heat treatment was conducted. From FIG. 2A, it can be seen that the surface of the sample 1 is flat and smooth.

FIG. 2B is a scanning electron microscope (SEM) photograph showing the surface of a metal structure (sample 5) which was electrochemically surface-treated according to the present invention. From FIG. 2B, it can be seen that the surface of sample 5 is uneven and hollowed in one direction.

FIG. 2C is a scanning electron microscope (SEM) photograph showing the surface of a metal structure (sample 14) which was electrochemically surface-treated and then heat-treated according to the present invention. From FIG. 2C, it can be seen that, differently from FIG. 2B, an oxide layer having rough and pointed surfaces is uniformly formed on the surface of sample 14. EDS analysis which was performed in order to analyze the composition of the oxide layer showed that the amount of Al increased by at least 7 fold compared to that before the heat treatment, and that the amount of Fe and Cr decreased to 1/10 of its level prior to heat treatment.

FIG. 2D is a scanning electron microscope (SEM) photograph showing the surface of a metal structure (sample 21) which was only heat-treated without electrochemical surface treatment according to the present invention. From FIG. 2D, it can be seen that, differently from FIG. 2C, a non-uniform oxide layer, the surface particles of which are clustered and lumped, was formed on the surface of sample 21. Analyzing the composition of the oxide layer showed that the amount of Al was about 22%, which is less than that of the oxide layer of sample 14 which was heat-treated after the electrochemical surface treatment, and also showed that the oxide layer included a large amount of Fe and Cr.

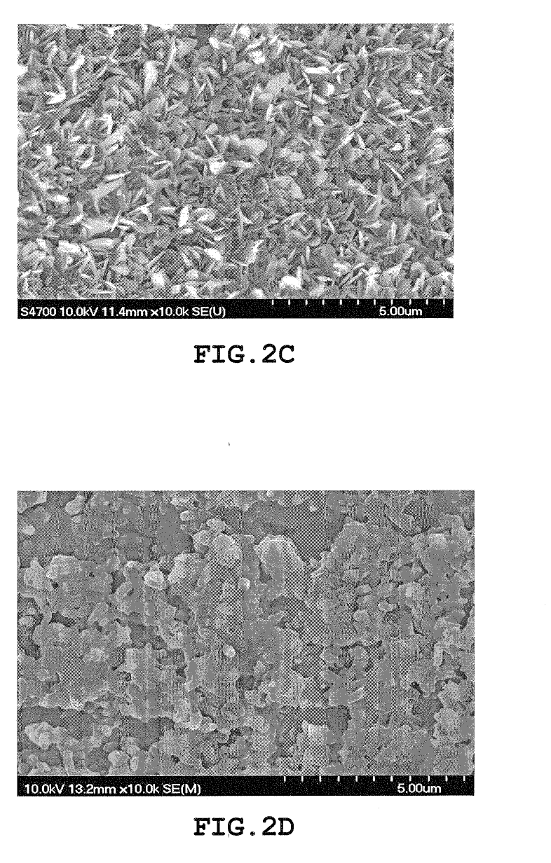

FIG. 3A is a scanning electron microscope (SEM) photograph showing the surface of a metal structure (sample 28) which was electrochemically surface-treated, heat-treated and then supported with nickel according to the present invention. As shown in FIG. 3, in the case of sample 28 which was electrochemically surface-treated and then supported with nickel, nickel particles are uniformly applied on the surface of an aluminum oxide layer formed on the metal support. Sample 28 is a sample supported with nickel according to an Example of metal structures given in the following Table 1.

In contrast, FIG. 3B is a scanning electron microscope (SEM) photograph showing the surface of a metal structure (sample 29) which was only heat-treated and then supported with nickel according to the present invention. As shown in FIG. 3B, in the case of sample 29 which was heat-treated and then supported with nickel, an aluminum oxide layer formed on the metal support is non-uniform, and nickel particles are non-uniformly supported on the aluminum oxide layer. Sample 29 is a sample supported with nickel according to a Comparative Example of metal structures given in Table 2 below.

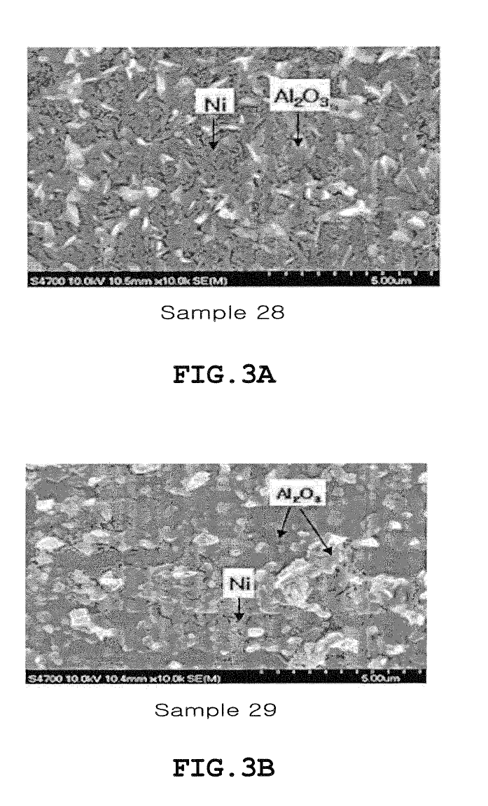

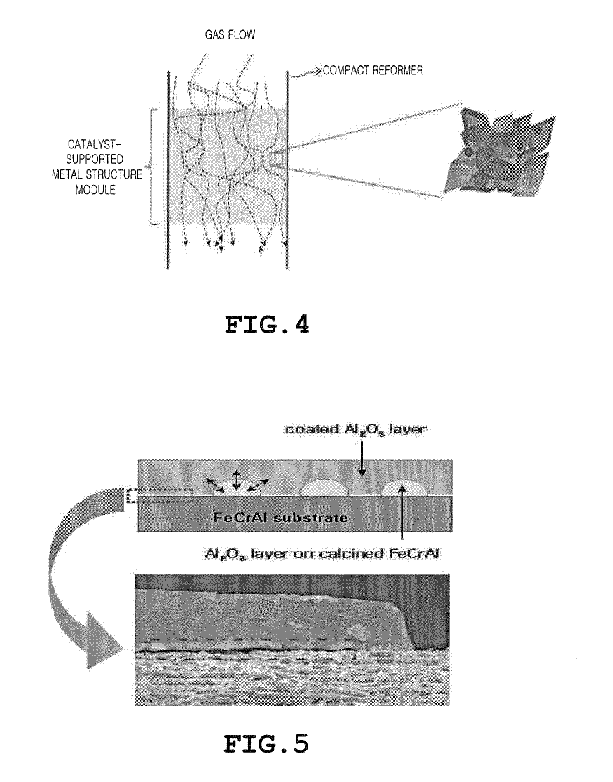

FIG. 4 is a schematic view showing a catalyst-supported metal structure module according to the present invention. FIG. 4 shows that the catalyst-supported metal structure module is configured such that the above-prepared catalyst-supported metal structures are irregularly layered to irregularly form reaction gas passages, thus improving contact between reaction gases and catalysts. Such a catalyst-supported metal structure module is mounted in a compact reformer prior to being used. The method of layering the catalyst-supported metal structures to complete the catalyst-supported metal structure module is not subject to any limitations. That is, the catalyst-supported metal structure module may be fabricated by simply layering the catalyst-supported metal structures regardless of the shape and size of a reactor or by corrugating the catalyst-supported metal structures and then arranging them within a narrow region. Since this catalyst-supported metal structure module is highly-dispersed with catalysts unlike a conventional pellet catalyst-packed reactor, catalytic usability can be maximized even when a small amount of catalyst per unit volume is used, and reaction efficiency can be increased because heat transfer and mass transfer are not greatly inhibited even when reaction gas is flowing at a fast velocity.

The conventional packed-bed catalytic reactor has an unavoidable problem of its size being increased because a large amount of catalyst must be used to treat a large amount of reactant per unit time. However, the treatment capacity of a reactant of the catalyst-supported metal structure module of the present invention can be increased by 20 fold or more compared to that of the conventional packed-bed catalytic reactor, so that its volume can be decreased to 1/20 normal size, thereby designing a compact reactor.

Hereinafter, the present invention will be described in more detail with reference to the following Examples.

### EXAMPLE 1

### Preparation of Metal Structure Samples

Table 1 shows samples prepared by electrochemically surface-treating a metal support made of Fecralloy or by electrochemically surface-treating and then heat-treating the metal support and analysis data of the compositions thereof. The analysis of the compositions of the samples was conducted through energy dispersive spectroscopy (EDS) using X-rays.

Sample 1 was prepared by washing a metal support with acetone and distilled water and then drying the metal support in order to remove pollutants.

Samples 2 to 10 were prepared by heat-treating a metal support in a 0.5% HF electrolyte solution while changing the applied voltage (5˜20 V) and the time (5˜30 min).

Samples 11 to 19 were prepared by electrochemically surface-treating samples 2 to 10 and then calcining them at 900° C. In particular, in order to evaluate the effect of calcination temperature, sample 20 was prepared by calcining sample 10 at 700° C. When electrochemical surface treatment was performed after heat treatment, the shape and composition of oxide is not advantageously modified, so this case was not considered.

It was found that, in samples 11 to 19 which were electrochemically surface-treated and then heat-treated, the aluminum content in the surfaces thereof increased by 7 fold or more compared to sample 1 which was only washed and samples 2 to 10 which were only chemically surface-treated, and that the surface roughness of samples 11 to 19 had greatly increased.

It was found that the aluminum content in the surface of sample 20 which was calcined at 700° C. was slightly increased, but that sample 20 required heat treatment at 900° C. or more in order to uniformly form an alumina layer on the entire surface of the metal support.

Further, it was found that aluminum content in the surface of samples 11 to 19, which had been electrochemically surface-treated and then heat-treated, were higher than those of samples 21 to 25 (given in Table 2 as Comparative Examples) which were washed and then calcined at 900° C.˜1000° C. without performing the electrochemical surface treatment. In the case of samples which were only heat-treated, it is clear that alumina layers were non-uniformly formed on the surfaces thereof.

### EXAMPLE 2

### Supporting Metal Structure with Nickel Catalysts

Sample 28 was prepared by surface-treating a metal support under the conditions of an applied voltage of 5 V and a surface treatment time of 30 min using the same method as in Example 1 and then heat-treating the surface-treated metal support at 900° C. for 6 hours. In order to support active metal nickel catalysts on sample 28, sample 28 was directly immersed in a nickel nitrate (NiNO₃)₂.6H₂O) precursor solution and then calcined.

### EXAMPLE 3

### Supporting Metal Structure with Nickel Catalysts After Coating the Metal Structure with a Catalyst Carrier Using a Binder

A boehmite sol coating was performed before nickel supporting after surface treatment and heat treatment using the same method as Example 2. When the metal structure is coated with a catalyst carrier, a small amount of a binder (PVA, acetic acid, citric acid or the like) may be added in order to increase adhesive force between the metal structure and the catalyst carrier.

Subsequently, the metal structure was immersed in a nickel precursor solution and then calcined.

### COMPARATIVE EXAMPLE 1

A metal structure made of Fecralloy was washed with acetone and distilled water without performing surface treatment as in the Examples, and was then calcined at 900˜1000° C.

Table 2 shows the results of analysis of the kind and composition of samples prepared by washing a metal support and then heat-treating the metal support without performing electrochemical surface treatment. A metal oxide layer was non-uniformly formed on the metal structure prepared in Comparative Example 1 because particles were agglomerated and clustered on the surface of the metal structure. Data analysis of the composition of the samples shows that the comparative samples have aluminum content lower than that of the samples (given in Table 1 as Examples) which were electrochemically surface-treated and then heat-treated, and that metal oxide layers containing a large amount of Fe and Cr were formed.

### COMPARATIVE EXAMPLE 2

Sample 29 was prepared by heat-treating a metal support at 900° C. for 6 hours using the same method as Comparative Example 1. The prepared sample 29 was boehmite-sol-coated, and was then immersed in a nickel precursor solution and then calcined. From this sample 29 supported with nickel, it can be seen that an alumina layer formed on the surface thereof is non-uniform and nickel is non-uniformly supported on the alumina layer. Sample 29 is a sample prepared by supporting comparative metal structure samples given in Table 2 with nickel, and is not mentioned in Table 2.

TABLE 1
Examples

| Atomic (%) | | Al | O | Ti | Cr | Fe | Si | Sample |
|---|---|---|---|---|---|---|---|---|
| Fresh | | 5.14 | 12.67 | — | 18.07 | 63.36 | 0.75 | 1 |
| Anodization | 2.5 V, 30 min | 5.44 | 9.81 | — | 19.22 | 65.52 | — | 2 |
| | 5 V, 5 min | 5.26 | 21.77 | — | 17.73 | 54.73 | 0.52 | 3 |
| | 5 V, 15 min | 5.67 | 15.79 | 0.35 | 18.52 | 59.22 | 0.46 | 4 |
| | 5 V, 30 min | 5.76 | 14.15 | 0.44 | 18.57 | 60.12 | 0.95 | 5 |
| | 10 V, 5 min | 5.49 | 17.06 | 0.42 | 18.42 | 58.05 | 0.55 | 6 |
| | 10 V, 15 min | 5.83 | 13.01 | — | 19.47 | 61.69 | — | 7 |
| | 10 V, 30 min | 5.55 | 16.31 | 0.99 | 18.51 | 57.92 | 0.72 | 8 |
| | 20 V, 5 min | 6.87 | 17.36 | | 17.77 | 58.01 | — | 9 |
| | 20 V, 15 min | 5.29 | 18.64 | 1.22 | 18.26 | 56.59 | — | 10 |
| Anodization- | 2.5 V, 30 min | 32.89 | 59.52 | — | 2.20 | 5.39 | — | 11 |
| calination | 5 V, 5 min | 33.99 | 55.57 | 0.20 | 2.98 | 7.26 | — | 12 |
| (900° C., 6 h) | 5 V, 15 min | 34.24 | 59.17 | 0.38 | 1.80 | 4.41 | — | 13 |
| | 5 V, 30 min | 36.11 | 56.55 | — | 2.18 | 5.16 | — | 14 |
| | 10 V, 5 min | 34.11 | 56.82 | — | 2.60 | 6.47 | — | 15 |
| | 10 V, 15 min | 30.85 | 55.22 | 0.65 | 3.45 | 9.82 | — | 16 |
| | 10 V, 30 min | 14.53 | 36.63 | 0.54 | 11.94 | 35.94 | 0.43 | 17 |
| | 20 V, 5 min | 26.35 | 52.31 | 0.39 | 5.85 | 15.10 | — | 18 |
| | 20 V, 15 min | 26.64 | 46.39 | 0.92 | 7.46 | 18.58 | — | 19 |
| Anodization- | 20 V, 15 min | 8.21 | 27.93 | 1.61 | 15.62 | 46.11 | 0.52 | 20 |
| calination | | | | | | | | |
| (700° C., 6 h) | | | | | | | | |

TABLE 2
Comparative Examples

| | | | | | | | | Sam- |
|---|---|---|---|---|---|---|---|---|
| Atomic (%) | Al | O | Ti | Cr | Fe | Si | C | ple |
| 900° C., 6 h | 21.68 | 45.73 | 0.28 | 8.21 | 24.10 | — | — | 21 |
| 900° C., 10 h | 22.44 | 47.95 | 0.34 | 7.32 | 21.62 | 0.33 | — | 22 |
| 950° C., 6 h | 22.62 | 49.71 | 0.62 | 6.94 | 19.75 | 0.35 | — | 23 |
| 950° C., 10 h | 23.25 | 46.36 | 0.72 | 6.56 | 18.13 | 0.25 | 4.6 | 24 |
| 950° C., 15 h | 21.11 | 44.37 | 0.59 | 6.96 | 20.09 | — | 6.52 | 25 |
| 1000° C., 6 h | 24.21 | 53.81 | 0.65 | 5.66 | 15.67 | — | — | 26 |
| 1000° C., 10 h | 26.40 | 54.02 | 0.95 | 5.14 | 13.49 | — | — | 27 |

As described above, the present invention is advantageous in that a uniform metal oxide layer can be formed on the surface of a metal support through an electrochemical surface treatment method, not a simple heat treatment method, the adhesive force between a metal structure and a catalyst can be increased, and the durability of a catalyst can be improved, in that a metal oxide layer containing desired metal components and having uniform roughness can be formed on a metal support by applying an electrochemical surface treatment technology even to a metal alloy support containing various components although a conventional electrochemical surface treatment technology is used to form a metal oxide layer on a single-component metal support, in that the shape and thickness of a metal oxide layer can be controlled by adjusting variables, such as the kind, pH and concentration of an electrolyte solution, voltage, voltage applying time and the like, and in that a metal oxide layer can be selectively formed by forming only a desired metal oxide layer on a metal support through heat treatment after electrochemical surface treatment.

Therefore, the novel catalyst-supported metal structure module having the above advantages is expected to be greatly used in the industrial fields of the invention because it can solve problems, such as the difficulty of scaling down due to space limitations, the decrease in thermal efficiency due to system miniaturization and the like, when it is applied to a compact fuel reformer.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of preparing a metal structure for a compact reformer, comprising the steps of:
washing a metal support to remove pollutants therefrom;
electrochemically surface-treating the washed metal support by controlling an applied voltage and an electrolyte concentration to form an amorphous metal oxide layer on the metal support; and
heat-treating the electrochemically surface-treated metal support in a heating furnace under an oxidation atmosphere to crystallize the amorphous metal oxide layer formed on the metal support or to form a metal oxide layer including a specific metal component.

2. The method of preparing a metal structure for a compact reformer according to claim 1, wherein, in the electrochemical surface-treatment step, any one selected from among copper coil, iron coil and platinum coil is used as a cathode, the metal support is used as an anode, the electrolyte is selected from fluorine acid, phosphoric acid, sodium fluoride, sodium nitrate and combinations thereof, and a voltage of 2˜30 V is applied between the cathode and the anode for 5˜60 minutes at room temperature.

3. The method of preparing a metal structure for a compact reformer according to claim 1, wherein the heat treatment step is performed under an oxidation atmosphere of 700˜1100° C.

4. The method of preparing a metal structure for a compact reformer according to claim 1, wherein the metal support is made of any one selected from among stainless steel, Fecralloy, aluminum, titanium and alloys thereof.

5. The method of preparing a metal structure for a compact reformer according to claim 1, wherein the metal support has an area opening percentage of 20˜60%.

6. The method of preparing a metal structure for a compact reformer according to claim 1, wherein the metal support has a ratio of channel length to channel diameter of 0.5 or less.

7. The method of preparing a metal structure for a compact reformer according to claim 1, further comprising a washing step between the electrochemical surface treatment step and the heat treatment step.

8. A metal structure for a compact reformer prepared using the method of any one of claims 1 to 7, wherein the metal oxide layer is uniformly formed on the surface of the metal support, and the metal structure has a large specific surface area.

9. A method of preparing a catalyst-supported metal structure for a compact reformer, comprising the steps of:
washing a metal support to remove pollutants therefrom;
electrochemically surface-treating the washed metal support by controlling an applied voltage and an electrolyte concentration to form an amorphous metal oxide layer on the metal support;
heat-treating the electrochemically surface-treated metal support in a heating furnace under an oxidation atmosphere to crystallize the amorphous metal oxide layer formed on the metal support or to form a metal oxide layer including a specific metal component, thus preparing a metal structure; and
supporting a catalyst on a surface of the metal structure.

10. The method of preparing a catalyst-supported metal structure for a compact reformer according to claim 9, further comprising the step of coating the metal oxide layer of the metal structure with a catalyst carrier to increase adhesive force between the metal structure and the catalyst, before the step of supporting the catalyst on the surface of the metal structure.

11. The method of preparing a catalyst-supported metal structure for a compact reformer according to claim 10, wherein the catalyst carrier is any one selected from among alumina, boehmite, silica and titania.

12. The method of preparing a catalyst-supported metal structure for a compact reformer according to claim 10, wherein, in the step of coating the metal oxide layer of the metal structure with the catalyst carrier, the metal oxide layer of the metal structure is coated with a mixture of the catalyst carrier and a binder to increase adhesive force between the metal structure and the catalyst.

13. The method of preparing a catalyst-supported metal structure for a compact reformer according to claim 12, wherein the binder is any one selected from among poly vinyl alcohol, acetic acid, citric acid, and poly ethylene glycol.

14. The method of preparing a catalyst-supported metal structure for a compact reformer according to claim 9, wherein the catalyst supported on the metal structure is any one selected from among nickel, platinum, ruthenium, ceria, zirconia, and a ceria-zirconia mixture.

15. The method of preparing a catalyst-supported metal structure for a compact reformer according to claim 9, wherein, in the electrochemical surface-treatment step, any one selected from among copper coil, iron coil and platinum coil is used as a cathode, the metal support is used as an anode, the electrolyte is selected from fluorine acid, phosphoric acid, sodium fluoride, sodium nitrate and combinations thereof, and a voltage of 2˜30 V is applied between the cathode and anode for 5˜60 minutes at room temperature.

16. The method of preparing a catalyst-supported metal structure for a compact reformer according to claim 9, wherein the heat treatment step is performed under an oxidation atmosphere of 700˜1100° C.

17. The method of preparing a catalyst-supported metal structure for a compact reformer according to claim 9, wherein the metal support is made of any one selected from among stainless steel, Fecralloy, aluminum, titanium and alloys thereof.

18. The method of preparing a catalyst-supported metal structure for a compact reformer according to claim 9, wherein the metal support has an area opening percentage of 20˜60%.

19. The method of preparing a catalyst-supported metal structure for a compact reformer according to claim 9, wherein the metal support has a ratio of channel length to channel diameter of 0.5 or less.

20. The method of preparing a catalyst-supported metal structure for a compact reformer according to claim 9, further comprising a washing step between the electrochemical surface treatment step and the heat treatment step.

21. A catalyst-supported metal structure for a compact reformer prepared using the method of any one of claims 9 to 20, wherein the catalyst is highly-dispersed and supported on the metal oxide layer.

22. A catalyst-supported metal structure module for a compact reformer, manufactured by irregularly layering a plurality of the catalyst-supported metal structures prepared using the method of any one of claims 9 to 20.
